(19) United States
(12) Patent Application Publication
(10) Pub. No.: US 2003/0137291 A1
(43) Pub. Date: Jul. 24, 2003

(54) Angle sensor with a magnetoelectrical converter element

(76) Inventors: Friedrich Wendel, Weissach (DE); Dieter Dick, Muehlacker (DE)

Correspondence Address: STRIKER, STRIKER & STENBY, 103 East Neck Road, Huntington, NY, 11743, US

(21) Appl. No.: 10/305,291

(22) Filed: Nov. 26, 2002

(30) Foreign Application Priority Data
Jan. 23, 2002 (DE) 102 02 319.0-42

(51) Int. Cl. G01B 7/30

(52) U.S. Cl. 324/207.2; 324/207.25

(57) ABSTRACT

An angle sensor includes at least one magnetoelectrical converter element (6, 7) and a magnetic circuit having at least one flux guide piece (2, 3, 4, 8; 12) and at least one magnet (5). By the motion of an element, an influence, measurable by the converter element (6, 7), on the magnetic flux is brought about. A first flux guide piece (2, 3, 4), the at least one magnet (5), and at least one converter element (6, 7) are located in an unaltered position relative to one another during the angle measurement, and a second flux guide piece (8) is rotatable relative to these parts (3, 4, 5, 6, 7). The magnetic field is evaluatable by the converter element (6, 7), and a variation in the magnetic field can be brought about by a variation in the air gap in the magnetic circuit during the rotation of the second flux guide piece (8).

### BACKGROUND OF THE INVENTION

The present invention relates to an angle sensor with at least one magnetoelectrical converter element for determination of rotational movement of a component.

DE 43 17 259 discloses a sensor arrangement for a rotational angle, in which a magnet flux generator for determination of a measurable magnetic flux is arranged in an electrical control device. Here, magnetoelectrical converter elements are provided, with which a change of the magnetic flux, generated by means of the rotational movement of a magnetic-conducting body, is determinable.

With the known magnetoelectrical converter elements, a measurable influence is used, which can then determine when the magnetic flux density is changed in the converter elements in dependence on the angle. This differs in practice, in that the magnetic circuit comprises flux guide pieces and permanent magnets, magnetically conducting flux guide pieces and the permanent magnets are rotated relative to one another and in this manner, the flux density on the converter elements changes.

It is known further from DE 197 53 775 A1 that with such measuring devices with a Hall element as the path sensor, flux guide pieces made from magnetically conducting material can be used for guiding the magnetic flux lines. In addition, EP 0 670 471 A1 discloses an arrangement, in which no parts that form the magnetic circuit, move relative to one another. Here, then, the entire magnetic circuit rotates via the magnetoelectrical converter. The measured effect is achieved by means of the fashioning of the magnets, which have a defined air gap change over the angle of rotation.

### SUMMARY OF THE INVENTION

With a further embodiment of an angle sensor of the above-described type with at least one magnetoelectrical converter element and a magnetic circuit comprising at least one conductance piece and at least one magnet, in which, by the movement of an element, an influence of the magnetic flux that is measurable with the converter element, can be brought about. A first flux guide piece, the last least one magnet, and the converter element are located in an unaltered position relative to one another during the angle measurement. Relative to these parts, according to the present invention, a second flux guide piece is moveable, whereby in an advantageous manner, a change of the magnetic field determinable by the converter element can be brought about through a change of the air gap in the magnetic circuit during the relative movement of the second flux guide piece.

According to an advantageous embodiment of the invention, the first fixed guide piece, along with the at least one magnet and the converter element, are located radially outward along the path of motion of the angle sensor. The second, rotationally moved flux guide piece is located radially inward at the center of the angle sensor, and in the course of its radial circumference, has a contour such that with it, because of the change in the width of the air gap from the magnet and/or from the at least one converter element, a predeterminable signal course in the converter element results.

The first flux guide piece can comprise two semicircular individual flux guide pieces, which each enclose one converter element, preferably Hall elements, such as, for example, Hall ICs. Here, in a simple manner, the magnet is kept facing the contour of the second, rotatable flux guide piece. Opposite the magnet, a correspondingly shaped protrusion can be present in the respective other individual flux guide piece.

On the other hand, also the first flux guide piece can comprise a full circle, on the inside of which the respective converter elements, and diametrically opposite it, the magnet are held. In this connection, it is advantageous that only two flux guide pieces are required, namely, a stator and a rotor, and that the total air gap with the Hall element and with the magnets also is the same upon radial bearing play in a first approximation so that, in this manner, no negative affects on the measured results take place.

The contour of the second flux guide piece can be shaped such that two radially opposed cams with a predetermined rising edge result for affecting an approximately linear signal course in the converter element up to an angle of approximately 140°. Through the radially opposed cams, this magnetic circuit is particularly axially insensitive. However, in another embodiment, it is contemplated that a single cam can be advantageously used.

### BRIEF DESCRIPTION OF THE DRAWINGS

FIG. 1 shows an angle sensor with a first, fixed flux guide piece made out of two parts and a second, rotatable flux guide piece and with a first arrangement of Hall elements and a magnet; and

FIG. 2 shows an angle sensor with a first, one-piece fixed flux guide piece and a second, rotatable flux guide piece and with a second arrangement of Hall elements and a magnet.

### DETAILED DESCRIPTION OF THE PREFERRED EMBODIMENTS

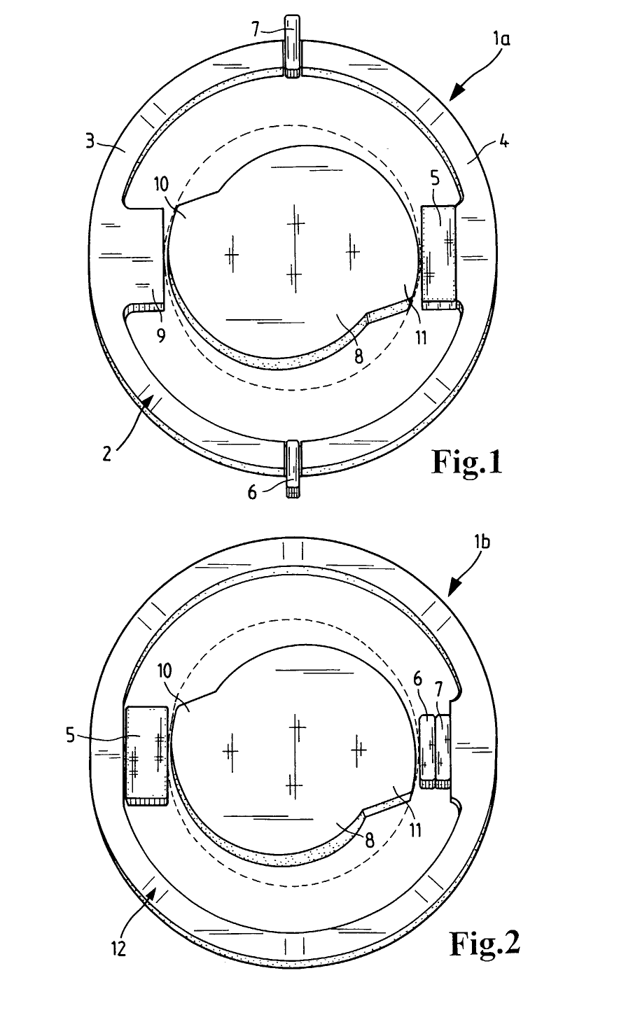

In FIG. 1, an angle sensor la is illustrated, which comprises a magnetic circuit including a first, outward-radially disposed flux guide piece 2 (stator) made from two, individual flux guide pieces 3 and 4, a permanent magnet 5, two Hall elements 6 and 7 as electromagnetic converters, and an inner, rotatable flux guide piece 8 (rotor).

The Hall elements 6 and 7 are oppositely disposed between the individual flux guide pieces 3 and 4 and the magnet 5 lies perpendicular thereto on the interior of the individual flux guide piece 4, whereby on the opposite flux guide piece 2, a corresponding protrusion 9 is formed, which has the same contour as the magnet 5.

The inner flux guide piece 8 is rotatable, whereby, through a suitable form of its outer contour, here with double cams 10 and 11 in the course of the rotational angle, to the magnet 5 and the protrusion 9, an air gap with a changeable gap width can be produced, by which, again, the magnetic flux in the entire magnetic circuit is changed. Based on a corresponding shape of the contour of the flux guide piece 8, a predeterminable signal course in the Hall elements 6, 7 is detectable during the rotational movement.

In FIG. 2, a second embodiment of an angle sensor lb is illustrated, in which a one-piece, first flux guide piece 12 is provided, in which the Hall elements 6, 7 and the magnet 5 are interiorly, oppositely disposed. The inner rotatable flux guide piece 8 is also here suited, with double cams 10, 11 in the course of the rotational angle, by a suitable shape of its outer contour, for producing an air gap with an alterable column width, as explained with reference to FIG. 1 above.

It will be understood that each of the elements described above, or two or more together, may also find a useful application in other types of constructions differing from the types described above.

While the invention has been illustrated and described herein as an angle sensor with a magnetoelectrical converter element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An angle sensor having at least one magnetoelectrical converter element (6, 7) and a magnetic circuit comprising at least one flux guide piece (2, 3, 4, 8; 12) and at least one magnet (5), in which, by the motion of an element, an influence, measurable by the converter element (6, 7), on a magnetic flux is brought about, characterized in that
a first flux guide piece (2, 3, 4), the at least one magnet (5), and at least one converter element (6, 7) are located in an unaltered position relative to one another during the angle measurement, and a second flux guide piece (8) is rotatable relative to these parts (3, 4, 5, 6, 7); and that
a variation in a magnetic field can be brought about by a variation in an air gap in the magnetic circuit during rotation of the second flux guide piece (8), wherein said magnetic field is evaluatable by the at least one converter element (6, 7).

2. The angle sensor of claim 1, wherein
the first fixed flux guide piece (2, 3, 4), along with the at least one magnet (5) and the converter element (6, 7), are located radially outward along the path of motion of the angle sensor (1); and wherein
the second, rotationally moved flux guide piece (8) is located radially inward at a center of the angle sensor (1), and in a course of a radial circumference of said second flux guide piece (8) has a contour such that with it, because of a change in a width of the air gap from the at least one magnet (5) and/or from the at least one converter element (6, 7), a predeterminable signal course in the converter element (6, 7) results.

3. The angle sensor of claim 2, wherein
the first flux guide piece (2) comprises two semicircular individual flux guide pieces (3, 4), wherein each of said semicircular flux guide pieces (3, 4) encloses one at least one converter element (6, 7) at their connecting point; and wherein
the at least one magnet (5) on one of the individual flux guide pieces (4) is kept facing the contour of the second rotatable flux guide piece (8).

4. The angle sensor of claim 3, wherein opposite the at least one magnet (5), a correspondingly shaped protrusion (7) is present in a respectively other individual flux guide piece (3).

5. The angle sensor of claim 2, wherein the first flux guide piece (12) comprises a full circle, wherein on an inside of said full circle, respective said at least one converter elements (6, 7) and diametrically opposite it, the at least one magnet (5) are held.

6. The angle sensor of claim 3, wherein a contour of the second flux guide piece (8) is shaped such that two radially opposed cams (10, 11) with a predetermined rising edge result.

7. The angle sensor of claim 1, wherein the at least one converter element is a Hall element (6, 7).
